(19) United States
(12) Patent Application Publication
(10) Pub. No.: US 2026/0136366 A1
(43) Pub. Date: May 14, 2026

(54) PUCCH RESOURCE FOR MSG4 HARQ FEEDBACK REPETITION

(71) Applicant: Nokia Technologies Oy, Espoo (FI)

(72) Inventors: Sami-Jukka HAKOLA, Oulu (FI); Chunli WU, Beijing (CN); Ping YUAN, Beijing (CN); Samuli Heikki TURTINEN, Oulu (FI)

(21) Appl. No.: 19/119,160

(22) PCT Filed: Oct. 11, 2022
(86) PCT No.: PCT/CN2022/124727

§ 371 Date: Apr. 8, 2025

(51) Int. Cl. H04W 72/21; H04L 1/1812

(52) U.S. Cl. CPC H04W 72/21; H04L 1/1812

(57) ABSTRACT

An apparatus includes at least one processor; and at least one memory storing instructions that, when executed by the at least one processor, cause the apparatus at least to: receive a message with a physical downlink shared channel; determine a physical uplink control channel resource used for transmission of a hybrid automatic repeat request acknowledgement, based on the message received with the physical downlink shared channel; wherein the physical uplink control channel resource is used for repetition of transmissions; and transmit the hybrid automatic repeat request acknowledgment, using the determined physical uplink control channel resource for repetition.

### TECHNICAL FIELD

The examples and non-limiting example embodiments relate generally to communications and, more particularly, to a PUCCH resource for msg4 HARQ feedback repetition.

### BACKGROUND

It is known to implement a random access response procedure in a communication network.

### SUMMARY

In accordance with an aspect, an apparatus includes at least one processor; and at least one memory storing instructions that, when executed by the at least one processor, cause the apparatus at least to: receive a message with a physical downlink shared channel; determine a physical uplink control channel resource used for transmission of a hybrid automatic repeat request acknowledgement, based on the message received with the physical downlink shared channel; wherein the physical uplink control channel resource is used for repetition of transmissions; and transmit the hybrid automatic repeat request acknowledgment, using the determined physical uplink control channel resource for repetition.

In accordance with an aspect, an apparatus includes at least one processor; and at least one memory storing instructions that, when executed by the at least one processor, cause the apparatus at least to: transmit a message with a physical downlink shared channel; and receive a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

In accordance with an aspect, a method includes receiving a message with a physical downlink shared channel; determining a physical uplink control channel resource used for transmission of a hybrid automatic repeat request acknowledgement, based on the message received with the physical downlink shared channel; wherein the physical uplink control channel resource is used for repetition of transmissions; and transmitting the hybrid automatic repeat request acknowledgment, using the determined physical uplink control channel resource for repetition.

In accordance with an aspect, a method includes transmitting a message with a physical downlink shared channel; and receiving a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

In accordance with an aspect, an apparatus includes means for receiving a message with a physical downlink shared channel; means for determining a physical uplink control channel resource used for transmission of a hybrid automatic repeat request acknowledgement, based on the message received with the physical downlink shared channel; wherein the physical uplink control channel resource is used for repetition of transmissions; and means for transmitting the hybrid automatic repeat request acknowledgment, using the determined physical uplink control channel resource for repetition.

In accordance with an aspect, an apparatus includes means for transmitting a message with a physical downlink shared channel; and means for receiving a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

In accordance with an aspect, a non-transitory program storage device readable by a machine, tangibly embodying a program of instructions executable with the machine for performing operations is provided and described, the operations including: receiving a message with a physical downlink shared channel; determining a physical uplink control channel resource used for transmission of a hybrid automatic repeat request acknowledgement, based on the message received with the physical downlink shared channel; wherein the physical uplink control channel resource is used for repetition of transmissions; and transmitting the hybrid automatic repeat request acknowledgment, using the determined physical uplink control channel resource for repetition.

In accordance with an aspect, a non-transitory program storage device readable by a machine, tangibly embodying a program of instructions executable with the machine for performing operations is provided and described, the operations including: transmitting a message with a physical downlink shared channel; and receiving a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example PUCCH-Config information element.

FIG. 3 shows an example PUCCH-Resource information element.

FIG. 4 shows an example PUCCH-ResourceExt-v1610 information element.

FIG. 5 is a table showing resource sets before dedicated PUCCH resource configuration.

FIG. 6 is an example apparatus configured to implement the examples described herein.

FIG. 7 shows a representation of an example of non-volatile memory media.

FIG. 8 is an example method implementing the examples described herein.

FIG. 9 is an example method implementing the examples described herein.

### DETAILED DESCRIPTION OF EXAMPLE EMBODIMENTS

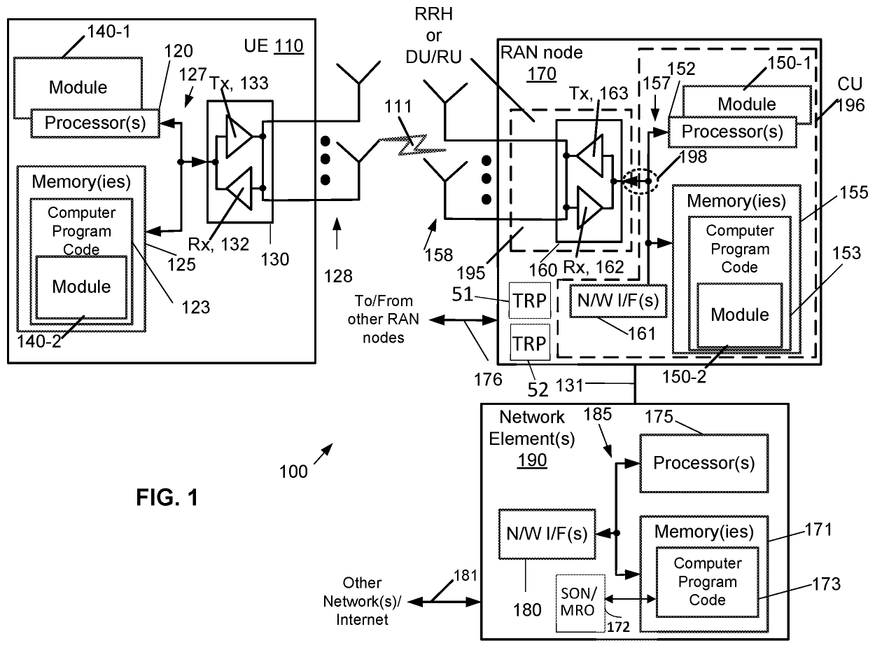

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, it is the functionality which carries UE functionalities. The distributed unit part of the IAB node facilitates the so called access link (child link) connections (i.e. for access link UEs, and backhaul for other IAB nodes, in the case of multi-hop IAB). In other words, it is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including a PUCCH resource for msg4 HARQ feedback repetition. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

In the RAN1 #110 meeting, coverage enhancement for NTNs has been discussed with the conclusion to enhance the PUCCH for MSG4 HARQ-ACK. ‘RAN1 concluded that the PUCCH for Msg4 HARQ-ACK should be enhanced to meet the coverage requirements’ (quotes added for emphasis) for parameter set-1 for LEO-1200 operating at LOS, assuming −5 dBi UE antenna gain.

It is also reflected in the updated Rel-18 WID for NTN in RP-222654. The detailed objectives are for an NTN ‘to specify PUCCH enhancements for Msg4 HARQ-ACK (e.g. repetition) [RAN1, RAN4]’ (quotes added for emphasis), and to study DMRS bundling for the PUSCH taking into account NTN-specifics (e.g. time-frequency pre-compensation) and, if necessary, specify enhancements to the Rel-17 procedures [RAN1].

PUCCH repetition for a dedicated PUCCH resource was already introduced in the Rel-17 coverage enhancement WI, with the number of possible repetitions configured per PUCCH resource and the PUCCH resource indicator field in the DCI could indicate which resource to use hence the number of repetitions to apply.

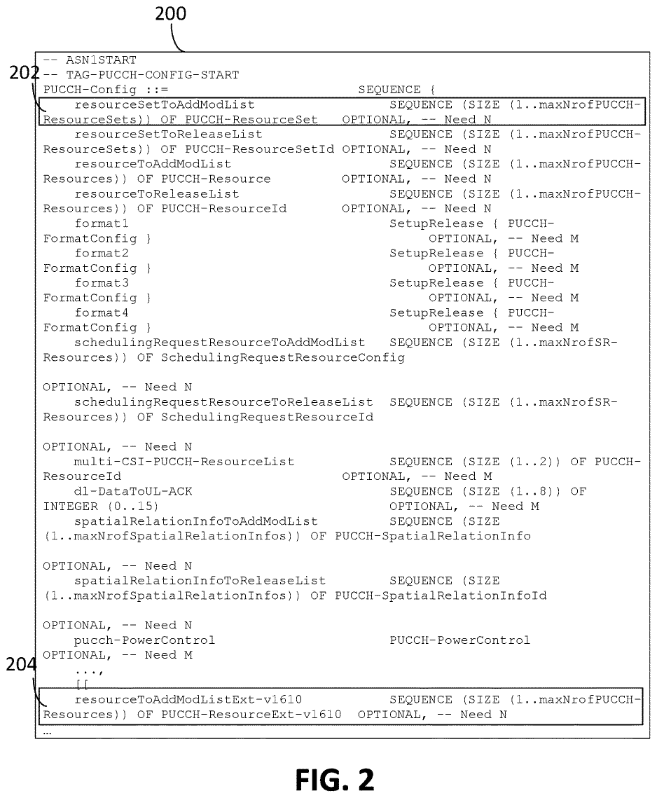

TS 38.331 describes a PUCCH-Config information element (IE). The IE PUCCH-Config IE is used to configure UE specific PUCCH parameters (per BWP). FIG. 2 shows an example PUCCH-Config information element 200, which PUCCH-Config information element 200 is also shown below:

-- ASN1START
-- TAG-PUCCH-CONFIG-START

| | |
|---|---|
| PUCCH-Config ::= | SEQUENCE { |
| resourceSetToAddModList | SEQUENCE (SIZE |

(1..maxNrofPUCCH-ResourceSets)) OF PUCCH-ResourceSet
OPTIONAL, -- Need N

| | |
|---|---|
| resourceSetToReleaseList | SEQUENCE (SIZE |

(1..maxNrofPUCCH-ResourceSets)) OF PUCCH-ResourceSetId
OPTIONAL, -- Need N

| | |
|---|---|
| resourceToAddModList | SEQUENCE (SIZE |

(1..maxNrofPUCCH-Resources)) OF PUCCH-Resource
OPTIONAL, -- Need N

| | |
|---|---|
| resourceToReleaseList | SEQUENCE (SIZE |

(1..maxNrofPUCCH-Resources)) OF PUCCH-ResourceId
OPTIONAL, -- Need N

| | |
|---|---|
| format1 | SetupRelease |

{ PUCCH-FormatConfig }
OPTIONAL, -- Need M

| | |
|---|---|
| format2 | SetupRelease |

{ PUCCH-FormatConfig }
OPTIONAL, -- Need M

| | |
|---|---|
| format3 | SetupRelease |

{ PUCCH-FormatConfig }
OPTIONAL, -- Need M

| | |
|---|---|
| format4 | SetupRelease |

{ PUCCH-FormatConfig }
OPTIONAL, -- Need M

| | |
|---|---|
| schedulingRequestResourceToAddModList | SEQUENCE (SIZE |

(1..maxNrofSR-Resources)) OF
SchedulingRequestResourceConfig
OPTIONAL, -- Need N

| | |
|---|---|
| schedulingRequestResourceToReleaseList | SEQUENCE (SIZE |

(1..maxNrofSR-Resources)) OF SchedulingRequestResourceId
OPTIONAL, -- Need N

| | |
|---|---|
| multi-CSI-PUCCH-ResourceList | SEQUENCE (SIZE |

(1..2)) OF PUCCH-ResourceId
OPTIONAL, -- Need M

| | |
|---|---|
| dl-DataToUL-ACK | SEQUENCE (SIZE |

(1..8)) OF INTEGER (0..15)
OPTIONAL, -- Need M

| | |
|---|---|
| spatialRelationInfoToAddModList | SEQUENCE (SIZE |

(1..maxNrofSpatialRelationInfos)) OF PUCCH-
SpatialRelationInfo
OPTIONAL, -- Need N

| | |
|---|---|
| spatialRelationInfoToReleaseList | SEQUENCE (SIZE |

(1..maxNrofSpatialRelationInfos)) OF PUCCH-
SpatialRelationInfoId
OPTIONAL, -- Need N

| | |
|---|---|
| pucch-PowerControl | PUCCH- |

```
PowerControl
OPTIONAL, -- Need M
  ...,
  [[
```

| | |
|---|---|
| resourceToAddModListExt-v1610 | SEQUENCE (SIZE |

(1..maxNrofPUCCH-Resources)) OF PUCCH-ResourceExt-v1610
OPTIONAL, -- Need N
...

FIG. 2 further shows the resourceSetToAddModList information element 202 and the resource ToAddMostListExt-v1610 information element 204.

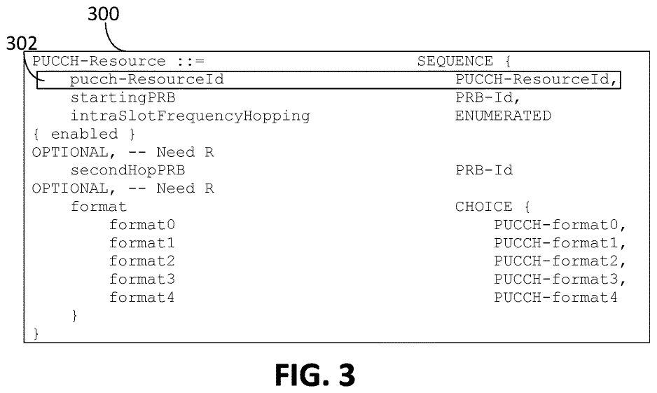

FIG. 3 and also below shows the PUCCH-Resource information element 300 which includes the pucch-ResourceId syntax element 302.

| PUCCH-Resource ::= | SEQUENCE { |
|---|---|
| pucch-ResourceId | PUCCH- |
| ResourceId, | |
| startingPRB | PRB-Id, |
| intraSlotFrequencyHopping | ENUMERATED |
| { enabled } | |
| OPTIONAL, -- Need R | |
| secondHopPRB | PRB-Id |
| OPTIONAL, -- Need R | |
| format | CHOICE { |
| format0 | PUCCH- |
| format0, | |
| format1 | PUCCH- |
| format1, | |
| format2 | PUCCH- |
| format2, | |
| format3 | PUCCH- |
| format3, | |
| format4 | PUCCH- |

format4
}
}

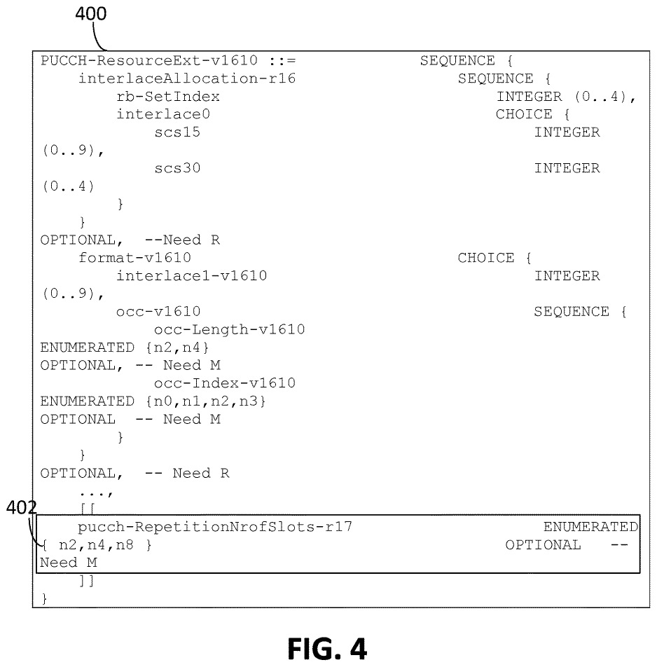

FIG. 4 and also below shows the PUCCH-ResourceExt-v1610 information element 400 which includes the pucch-RepetitionNrofSlots-r17 syntax element 402.

| PUCCH-ResourceExt-v1610 ::= | SEQUENCE { |
|---|---|
| interlaceAllocation-r16 | SEQUENCE { |
| rb-SetIndex | INTEGER |
| (0..4), | |
| interlace0 | CHOICE { |
| scs15 | INTEGER |
| (0..9), | |
| scs30 | INTEGER |
| (0..4) | |
| } | |
| } | |
| OPTIONAL, --Need R | |
| format-v1610 | CHOICE { |
| interlace1-v1610 | INTEGER |
| (0..9), | |
| occ-v1610 | SEQUENCE |

```
{
      occ-Length-v1610
ENUMERATED {n2,n4}
OPTIONAL, -- Need M
      occ-Index-v1610
ENUMERATED {n0, n1, n2, n3}
OPTIONAL -- Need M
    }
  }
OPTIONAL, -- Need R
  ...,
  [[
  pucch-RepetitionNrofSlots-r17
ENUMERATED { n2, n4, n8 }
OPTIONAL -- Need M
  ]]
}
```

As also indicated in TS 38.331:
“resourceToAddModList, resourceToAddModListExt, resourceToReleaseList

Lists are defined for adding and releasing PUCCH resources applicable for the UL BWP and serving cell in which the PUCCH-Config is defined. The resources defined herein are referred to from other parts of the configuration to determine which resource the UE shall use for which report. ‘If the network includes resource ToAddModListExt, it includes the same number of entries, and listed in the same order, as in resource ToAddModList (emphasis in quotes (‘ ’)).”

TS 38. 213 describes a UE procedure for reporting HARQ-ACK, as follows with quotes (‘ ’) added:

### “9.2.3 UE Procedure for Reporting HARQ-ACK

In this clause, for the purpose of determining a PUCCH resource for a PUCCH transmission in a slot using ‘a PUCCH resource indicator field in a DCI format that schedules a PDSCH reception’, and for the purpose of determining the slot for the PUCCH transmission:
a UE is assumed to generate HARQ-ACK information regardless of whether or not the PDSCH reception provides a transport block for a HARQ process with disabled HARQ-ACK information as indicated by the HARQ-feedbackEnabling-disablingper HARQprocess, if provided
a UE is assumed to not generate HARQ-ACK information associated with a G-RNTI or a G-CS-RNTI with disabled HARQ-ACK information as described in clause 18.”

TS 38. 212 describes Format 1_0, as follows with quotes (‘ ’) added:
“7.3.1.2.1 Format 1_0

DCI format 1_0 is used for the scheduling of PDSCH in one DL cell.
. . .
   PUCCH resource indicator—3 bits as defined in Clause 9.2.3 of [5, TS 38.213]′
PDSCH-to-HARQ_feedback timing indicator—3 bits as defined in Clause 9.2.3 of [5, TS38.213].”

MSG3 repetition was also supported in the Rel-17 coverage enhancement WI, including in the description of PUSCH scheduled by a RAR UL grant, as follows (with quotes (‘ ’) added):
“8.3 PUSCH Scheduled by RAR UL Grant
. . .

A UE can be provided in RACH-ConfigCommon a set of numbers of repetitions for a PUSCH transmission with PUSCH repetition Type A that is scheduled by a RAR UL grant or by a DCI format 0_0 with CRC scrambled by a TC-RNTI. If the UE requests repetitions for the PUSCH transmission [11, TS 38.321], ‘the UE transmits the PUSCH over

$${N}_{PUSCH}^{repeat}$$

slots, where

$${N}_{PUSCH}^{repeat}$$

is indicated by the 2 Mbps of the MCS field in the RAR UL grant or in the DCI format 0_0 from a set of four values provided by numberOfMsg3Repetitions or from {1, 2, 3, 4} if numberOfMsg3Repetitions is not provided’. The UE determines an MCS for the PUSCH transmission by the 2 LSBs of the MCS field in the RAR UL grant or by the 3 LSBs of the MCS field in the DCI format 0_0, and determines a redundancy version and RBs for each repetition as described in [6, TS 38.214]. For unpaired spectrum operation, the UE determines the

$${N}_{PUSCH}^{repeat}$$

slots as the first

$${N}_{PUSCH}^{repeat}$$

slots starting from slot n+k₂+Δ where a repetition of the PUSCH transmission does not include a symbol indicated as downlink by tdd-UL-DL-ConfigurationCommon or indicated as a symbol of an SS/PBCH block with index provided by ssb-PositionsInBurst.”

Type A refers to PUSCH transmission with PUSCH repetition Type A: the UE can transmit PUSCHs in several repetitions without feedback scheduled by an UL grant or RRC in the consecutive available slots. This method is called PUSCH repetition Type A.

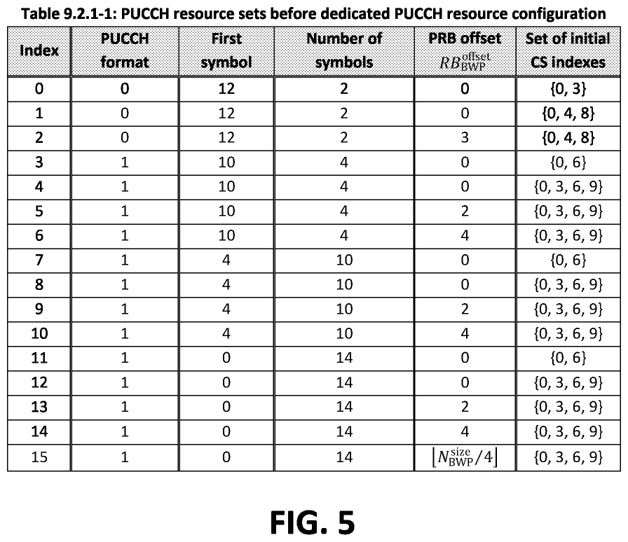

It is currently not possible to support PUCCH repetition for MSG4 feedback before the UE has a dedicated PUCCH configuration, as the number of repetitions is configured in the dedicated PUCCH-Config. Before the UE has a dedicated PUCCH resource, the UE decides the PUCCH resource based on the table defined in 38.213 (shown herein and in FIG. 5) with an index configured in the SIB:

TS 38.213 also describes PUCCH resource sets, as follows, with quotes (‘ ’) added for emphasis:
“9.2.1 PUCCH Resource Sets

‘If a UE does not have a dedicated PUCCH resource configuration, provided by PUCCH-ResourceSet in PUCCH-Config, a PUCCH resource set is provided by pucch-ResourceCommon through an index to a row of Table 9.2.1-1 for transmission of HARQ-ACK information on PUCCH in an initial UL BWP of

$${N}_{BWP}^{size}$$

PRBs.’ For operation in FR2-2, pucch-ResourceCommon can also provide a number of N_{RB} RBs for the PUCCH resource set; otherwise N_{RB}=1.
. . .

If a UE is provided a PUCCH resource by pucch-ResourceCommon and is provided useInterlacePUCCH-PUSCH in BWP-UplinkCommon
the UE determines for the PUCCH resource an interlace index m as m=(m₀+[r_{PUCCH}/N_{CS}]) modM where M is a number of interlaces [4, TS 38.211] and

$${m}_{0} = R {B}_{BWP}^{offset}$$

is an interlace index offset and

$$R {B}_{BWP}^{offset}$$

is as given in Table 9.2.1-1
the UE determines an initial cyclic shift index in a set of initial cyclic shift indexes as r_{PUCCH} modN_{CS}, where N_{CS} is the total number of initial cyclic shifts indexes in the set of initial cyclic shift indexes in Table 9.2.1-1
if pucch-ResourceCommon indicates
   index 0: the first symbol is 9 for a PUCCH resource with PUCCH format 0 if r_{PUCCH}≥10
   index 1 or 2: the first symbol is 9 for a PUCCH resource with PUCCH format 0 if r_{PUCCH}=15
   index 3, 7, or 11: an orthogonal cover code with index 1 is used for a PUCCH resource with PUCCH format 1 if r_{PUCCH}≥10; otherwise, an orthogonal cover code with index 0 is used for a PUCCH resource with PUCCH format 1
the UE does not expect pucch-ResourceCommon to indicate index 15.”

FIG. 5 shows Table 9.2.1-1 from TS 38.213, also given below (quotes (‘ ’) added for emphasis):

TABLE 9.2.1-1
PUCCH resource sets before dedicated PUCCH resource configuration

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

The issue how to define the PUCCH resources for the repetitions to avoid collision with legacy UEs sending PUCCH and mitigate or randomize inter-cell interference is to be solved to support PUCCH repetition for MSG4 HARQ-ACK before the UE has dedicated PUCCH resources configured.

Thus, described herein is a method to determine the PUCCH resource for repetition before the UE has dedicated PUCCH configuration. In more details, the following options can be individual options or combined together.

In one option, the PUCCH resource is kept fixed, i.e. as the same as provided in the DCI, for all the PUCCH repeated transmissions. In this option, a PRB offset hopping pattern could be defined (e.g. in the specification or provided in the configuration of common PUCCH resources) and applied per each repetition.

The PRB offset hopping pattern could be derived at least partly based on cell ID:
mod (cell ID, 4)==0 then the pattern is {0, 1, 2, 3}
mod (cell ID, 4)==1 then the pattern is {1, 2, 3, 0}
mod (cell ID, 4)==2 then the pattern is {2, 3, 0, 1}
mod (cell ID, 4)==3 then the pattern is {3, 0, 1, 2}

In another option, the PUCCH resource is changed for each repeated transmission in a pre-determined manner. In this option a resource hopping pattern could be introduced.

The hopping pattern could be fixed:
1st transmission: r_pucch determined according to APRI in DCI (mod(r_pucch+n(0), 16))
2nd transmission: r_pucch determined mod(r_pucch+n(1), 16)
3rd transmission: r_pucch determined mod(r_pucch+n(2), 16)
4th transmission: r_pucch determined mod(r_pucch+n(3), 16)
where n={0, 1, 2, 3} (then n(1)=1, n(2)=2, n(3)=3)

The hopping could be partly based on cell ID, e.g.
n(0) in above formula is mod (cellID, 4)
n(1) in above formula is mod (cellID+1, 4)
n(2) in above formula is mod (cellID+2, 4)
n(3) in above formula is mod (cellID+3, 4)

PRB offset hopping per repetition could be introduced for the repetition resource and/or symbols offset for those indexes not using the whole slot.

In yet another option, a new indication in the DCI triggering the HARQ ACK is used to indicate to the UE whether the starting symbol is 0/2 (this could specified in the specification which one it is) or what is actually defined in the table (legacy starting symbol). In this option, if the DCI indicates the starting symbol 0/2 (or implicitly e.g. based on whether or not Msg3 PUSCH is transmitted in a repeated manner) for the indices 0-6, the UE determines that the starting symbol is 0/2 and that the UE transmits the PUCCH resource in a repeated manner in the same slot.

For example, if the row index provided is 0 and explicit indication (or implicit determination) says that the starting symbol is 2 (new behavior), then the UE determines that there are multiple transmissions (repetitions) in that slot:
E.g. in case of row indices 0, 1 or 2, then 6 PUCCH transmissions.
E.g. in case of row indices 3, 4, 5 or 6, then 3 PUCCH transmissions

For determining the number of repetitions for MSG4 HARQ-ACK before the UE has a dedicated PUCCH configuration, the following options could be considered:

In one option, the number of repetitions for MSG4 HARQ-ACK before the UE has a dedicated PUCCH configuration could be derived from MSG3 repetition as indicated in the RAR UL grant. The same number of repetitions as MSG3 could be used, or a certain scale number can be defined/configured. For instance, the network could configure the number of repetitions to be less or more than the MSG3 repetitions as indicated in the RAR UL grant or in the SIB. In one option, MSG4 HARQ-ACK repetition is not performed by the UE if no repetition is indicated for MSG3.

Alternatively, the number of repetitions for MSG4 HARQ-ACK before the UE has a dedicated PUCCH configuration could be explicitly indicated in DCI scheduling MSG4/MSGB or in the MSGB payload. It should be noted that if the DCI option is employed for 2-step RACH (i.e., DCI scheduling MSGB, the same repetition number is applied by the UEs receiving that MSGB). In one option, the current PUCCH resource indicator field could be reused with a different interpretation before the UE has a dedicated PUCCH configuration, e.g., with the number of repetitions mapped to each value predefined or pre-configured in the SIB. In one option, the number of repetitions is indicated in the DCI scheduling MSGB and the applicability of MSGB HARQ-ACK repetition is indicated per each UE in the MSGB payload.

The PUCCH repetitions could be in consecutive slots or in the same pattern as the MSG3 repetition. Only valid slots are considered (e.g. in case of TDD). When the repetitions collide with DL slots, they are dropped or postponed to next valid slot. The number of repetitions could be associated with an index (e.g., through SIB signaling) and the index is indicated to the UE through the above means based on which the UE derives the number of repetitions.

Advantages and technical effects of the examples described herein include that PUCCH repetition is supported for MSG4 HARQ-Ack before dedicated PUCCH configuration without colliding with the legacy common PUCCH resources. The examples described herein may be adopted and specified within TS 38.331 and/or TS 38.213.

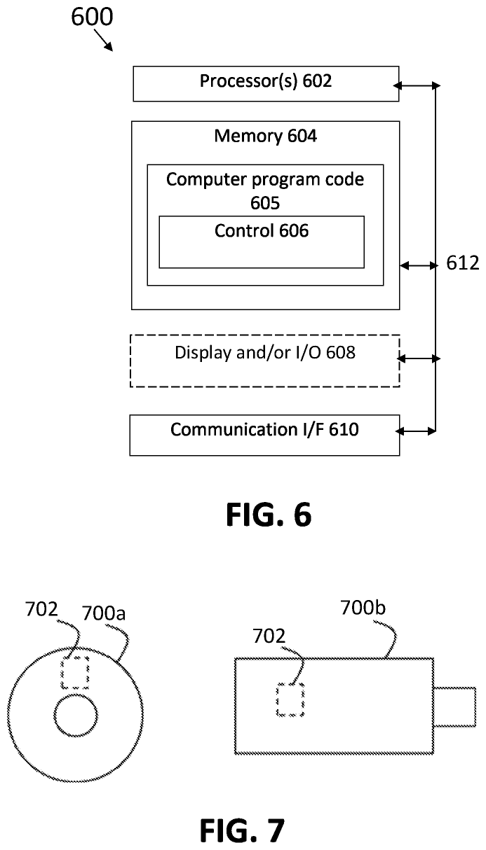

FIG. 6 is an example apparatus 600, which may be implemented in hardware, configured to implement the examples described herein. The apparatus 600 comprises at least one processor 602 (e.g. an FPGA and/or CPU), at least one memory 604 including computer program code 605, wherein the at least one memory 604 and the computer program code 605 are configured to, with the at least one processor 602, cause the apparatus 600 to implement circuitry, a process, component, module, or function (collectively control 606) to implement the examples described herein, including a PUCCH resource for msg4 HARQ feedback repetition. The memory 604 may be a non-transitory memory, a transitory memory, a volatile memory (e.g. RAM), or a non-volatile memory (e.g. ROM).

The apparatus 600 optionally includes a display and/or I/O interface 608 that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 600 includes one or more communication e.g. network (N/W) interfaces (I/F(s)) 610. The communication I/F(s) 610 may be wired and/or wireless and communicate over the Internet/other network(s) via any communication technique. The communication I/F(s) 610 may comprise one or more transmitters and one or more receivers. The communication I/F(s) 610 may comprise standard well-known components such as an amplifier, filter, frequency-converter, (de) modulator, and encoder/decoder circuitries and one or more antennas.

The apparatus 600 to implement the functionality of control 606 may be UE 110, RAN node 170 (e.g. gNB), or network element(s) 190. Thus, processor 602 may correspond to processor(s) 120, processor(s) 152 and/or processor(s) 175, memory 604 may correspond to memory(ies) 125, memory(ies) 155 and/or memory(ies) 171, computer program code 605 may correspond to computer program code 123, module 140-1, module 140-2, and/or computer program code 153, module 150-1, module 150-2, and/or computer program code 173, and communication I/F(s) 610 may correspond to transceiver 130, antenna(s) 128, transceiver 160, antenna(s) 158, N/W I/F(s) 161, and/or N/W I/F(s) 180. Alternatively, apparatus 600 may not correspond to either of UE 110, RAN node 170, or network element(s) 190, as apparatus 600 may be part of a self-organizing/optimizing network (SON) node, such as in a cloud.

The apparatus 600 may also be distributed throughout the network (e.g. 100) including within and between apparatus 600 and any network element (such as a network control element (NCE) 190 and/or the RAN node 170 and/or the UE 110).

Interface 612 enables data communication between the various items of apparatus 600, as shown in FIG. 6. For example, the interface 612 may be one or more buses such as address, data, or control buses, and may include any interconnection mechanism, such as a series of lines on a motherboard or integrated circuit, fiber optics or other optical communication equipment, and the like. Computer program code (e.g. instructions) 605, including control 606 may comprise object-oriented software configured to pass data or messages between objects within computer program code 605. The apparatus 600 need not comprise each of the features mentioned, or may comprise other features as well.

FIG. 7 shows a schematic representation of non-volatile memory media 700a (e.g. computer/compact disc (CD) or digital versatile disc (DVD)) and 700b (e.g. universal serial bus (USB) memory stick) storing instructions and/or parameters 702 which when executed by a processor allows the processor to perform one or more of the steps of the methods described herein.

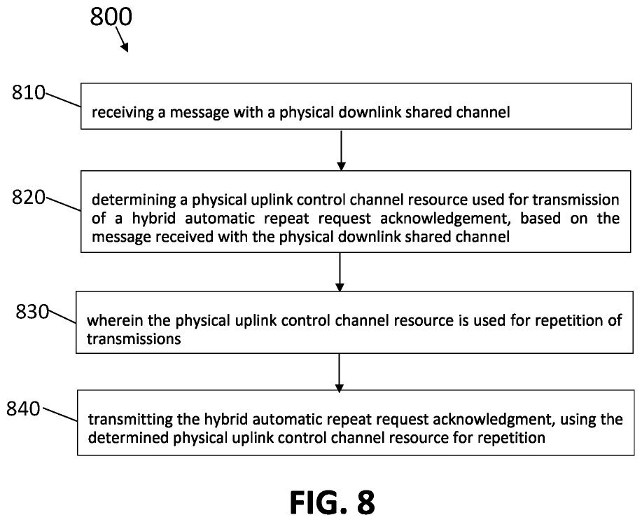

FIG. 8 is an example method 800 to implement the example embodiments described herein. At 810, the method includes receiving a message with a physical downlink shared channel. At 820, the method includes determining a physical uplink control channel resource used for transmission of a hybrid automatic repeat request acknowledgement, based on the message received with the physical downlink shared channel. At 830, the method includes wherein the physical uplink control channel resource is used for repetition of transmissions. At 840, the method includes transmitting the hybrid automatic repeat request acknowledgment, using the determined physical uplink control channel resource for repetition. Method 800 may be performed with UE 110 or apparatus 600.

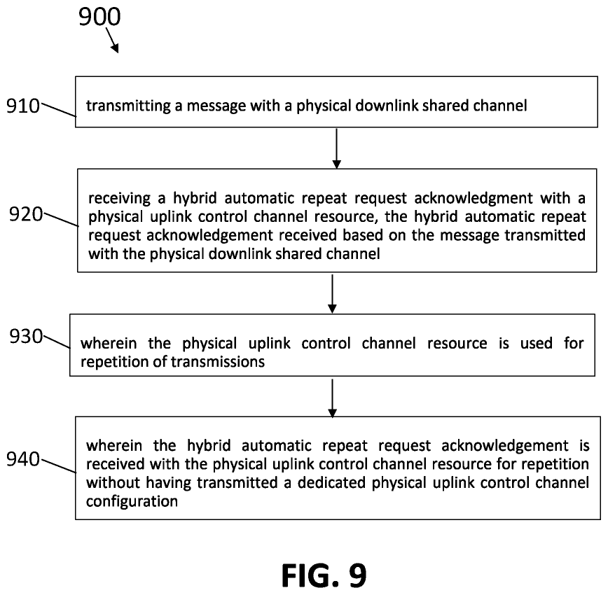

FIG. 9 is an example method 900 to implement the example embodiments described herein. At 910, the method includes transmitting a message with a physical downlink shared channel. At 920, the method includes receiving a hybrid automatic repeat request acknowledgment with a physical uplink control channel resource, the hybrid automatic repeat request acknowledgement received based on the message transmitted with the physical downlink shared channel. At 930, the method includes wherein the physical uplink control channel resource is used for repetition of transmissions. At 940, the method includes wherein the hybrid automatic repeat request acknowledgement is received with the physical uplink control channel resource for repetition without having transmitted a dedicated physical uplink control channel configuration. Method 900 may be performed with RAN node 170, network element(s) 190, or apparatus 600.

The following examples are provided and described herein.

Example 1. An apparatus includes at least one processor; and at least one memory storing instructions that, when executed by the at least one processor, cause the apparatus at least to: receive a message with a physical downlink shared channel; determine a physical uplink control channel resource used for transmission of a hybrid automatic repeat request acknowledgement, based on the message received with the physical downlink shared channel; wherein the physical uplink control channel resource is used for repetition of transmissions; and transmit the hybrid automatic repeat request acknowledgment, using the determined physical uplink control channel resource for repetition.

Example 2. The apparatus of example 1, wherein the apparatus is further caused to: determine the physical uplink control channel resource for repetition without having received a dedicated physical uplink control channel configuration.

Example 3. The apparatus of any of examples 1 to 2, wherein the physical uplink control channel resource is fixed for physical uplink control channel repeated transmissions.

Example 4. The apparatus of example 3, wherein the apparatus is caused to: receive downlink control information comprising the physical uplink control channel resource.

Example 5. The apparatus of any of examples 3 to 4, wherein the apparatus is caused to: determine a physical resource block offset hopping pattern for a repetition of the physical uplink control channel repeated transmissions; and apply the physical resource block offset hopping pattern for the repetition.

Example 6. The apparatus of example 5, wherein the physical resource block hopping pattern is predefined or provided within a configuration of common physical uplink control channel resources.

Example 7. The apparatus of any of examples 5 to 6, wherein the apparatus is caused to: determine the physical resource block hopping pattern at least partially based on a cell identifier.

Example 8. The apparatus of example 7, wherein the apparatus is caused to: determine, with a modulo function, a remainder of the cell identifier divided with an integer; and determine the physical resource block hopping pattern as a set of values, the set of values based on the determination of the remainder with the modulo function.

Example 9. The apparatus of any of examples 1 to 8, wherein the physical uplink control channel resource is changed for a respective physical uplink control channel repeated transmission of a plurality of physical uplink control channel repeated transmissions.

Example 10. The apparatus of example 9, wherein the apparatus is caused to: determine the physical uplink control channel resource for a repetition of the physical uplink control channel repeated transmissions, based on a resource offset indicator in downlink control information.

Example 11. The apparatus of any of examples 9 to 10, wherein the apparatus is caused to: determine a hopping pattern for the physical uplink control channel resource; and determine the physical uplink control channel resource for a repeated transmission based on the hopping pattern.

Example 12. The apparatus of example 11, wherein the apparatus is caused to: determine the hopping pattern at least partially based on a cell identifier.

Example 13. The apparatus of any of examples 9 to 12, wherein the apparatus is caused to: determine an initial value with adding a resource value associated with the physical uplink control channel resource to an output of a function given with a first integer; determine, with a modulo function, a remainder of the initial value divided with a second integer; determine the physical uplink control channel resource, based on the remainder determined with the modulo function.

Example 14. The apparatus of example 13, wherein the apparatus is caused to: determine another value with dividing a cell identifier with a third integer; wherein the output of the function given with the first integer comprises the another value.

Example 15. The apparatus of any of examples 9 to 14, wherein the apparatus is caused to: determine a physical resource block offset hopping pattern for a repetition of the physical uplink control channel repeated transmissions; and apply the physical resource block offset hopping pattern for the repetition.

Example 16. The apparatus of any of examples 9 to 15, wherein the apparatus is caused to: determine a symbols offset for indexes associated with the physical uplink control channel resource without using a whole slot.

Example 17. The apparatus of any of examples 1 to 16, wherein the apparatus is caused to: receive downlink control information, the downlink control information configured to trigger transmission of the hybrid automatic repeat request acknowledgement; wherein the downlink control information indicates a starting symbol; and transmit a repeated transmission with the physical uplink control channel resource repeatedly within a slot, based on the starting symbol.

Example 18. The apparatus of example 17, wherein: the downlink control information indicates the starting symbol explicitly; or the downlink control information indicates the starting symbol implicitly based on whether a message for a physical uplink shared channel is transmitted repeatedly.

Example 19. The apparatus of any of examples 17 to 18, wherein the starting symbol is 0 or 2.

Example 20. The apparatus of any of examples 17 to 19, wherein the apparatus is caused to: receive a row index with the downlink control information; and determine a number of physical uplink control channel repeated transmissions at least partially based on the row index.

Example 21. An apparatus includes at least one processor; and at least one memory storing instructions that, when executed by the at least one processor, cause the apparatus at least to: transmit a message with a physical downlink shared channel; and receive a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

Example 22. The apparatus of example 21, wherein the physical uplink control channel resource is fixed for physical uplink control channel repeated transmissions.

Example 23. The apparatus of example 22, wherein the apparatus is caused to: transmit downlink control information comprising the physical uplink control channel resource.

Example 24. The apparatus of any of examples 22 to 23, wherein the apparatus is caused to: receive a repetition of the physical uplink control channel repeated transmissions, based on a physical resource block offset hopping pattern.

Example 25. The apparatus of example 24, wherein the apparatus is caused to: transmit a configuration of common physical uplink control channel resources, the configuration comprising the physical resource block hopping pattern.

Example 26. The apparatus of any of examples 24 to 25, wherein the physical resource block hopping pattern is predefined.

Example 27. The apparatus of any of examples 24 to 26, wherein the physical resource block hopping pattern is based at least partially on a cell identifier.

Example 28. The apparatus of example 27, wherein the physical resource block hopping pattern comprises a set of values, the set of values based on a modulo function, the output of the modulo function being a remainder of the cell identifier divided with an integer.

Example 29. The apparatus of any of examples 21 to 28, wherein the physical uplink control channel resource is changed for a respective physical uplink control channel repeated transmission of a plurality of physical uplink control channel repeated transmissions.

Example 30. The apparatus of example 29, wherein the apparatus is caused to: transmit downlink control information comprising a resource offset indicator; receive a repetition of the physical uplink control channel repeated transmissions with the physical uplink control channel resource, based on the resource offset indicator in the downlink control information.

Example 31. The apparatus of any of examples 29 to 30, wherein the apparatus is caused to: receive a repetition of the physical uplink control channel repeated transmissions, based on a hopping pattern associated with the physical uplink control channel resource.

Example 32. The apparatus of example 31, wherein the hopping pattern is based at least partially on a cell identifier.

Example 33. The apparatus of any of examples 29 to 32, wherein the physical uplink control channel resource is based on a modulo function that determines a remainder of an initial value divided with a first integer, wherein the initial value is based on adding a resource value associated with the physical uplink control channel resource to an output of a function given with a second integer.

Example 34. The apparatus of example 33, wherein the output of the function given with the second integer comprises another value based on dividing a cell identifier with a third integer.

Example 35. The apparatus of any of examples 29 to 34, wherein the apparatus is caused to: receive a repetition of the physical uplink control channel repeated transmissions, based on a physical resource block offset hopping pattern.

Example 36. The apparatus of any of examples 29 to 35, wherein a symbols offset for indexes is associated with the physical uplink control channel resource without using a whole slot.

Example 37. The apparatus of any of examples 21 to 36, wherein the apparatus is caused to: transmit downlink control information, the downlink control information configured to trigger transmission of the hybrid automatic repeat request acknowledgement; wherein the downlink control information indicates a starting symbol; and receive a repeated transmission with the physical uplink control channel resource repeatedly within a slot, based on the starting symbol.

Example 38. The apparatus of example 37, wherein: the downlink control information indicates the starting symbol explicitly; or the downlink control information indicates the starting symbol implicitly based on whether a message for a physical uplink shared channel is transmitted repeatedly.

Example 39. The apparatus of any of examples 37 to 38, wherein the starting symbol is 0 or 2.

Example 40. The apparatus of any of examples 37 to 39, wherein the apparatus is caused to: transmit a row index with the downlink control information; wherein a number of physical uplink control channel repeated transmissions is based at least partially on the row index.

Example 41. A method includes receiving a message with a physical downlink shared channel; determining a physical uplink control channel resource used for transmission of a hybrid automatic repeat request acknowledgement, based on the message received with the physical downlink shared channel; wherein the physical uplink control channel resource is used for repetition of transmissions; and transmitting the hybrid automatic repeat request acknowledgment, using the determined physical uplink control channel resource for repetition.

Example 42. A method includes transmitting a message with a physical downlink shared channel; and receiving a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

Example 43. An apparatus includes means for receiving a message with a physical downlink shared channel; means for determining a physical uplink control channel resource used for transmission of a hybrid automatic repeat request acknowledgement, based on the message received with the physical downlink shared channel; wherein the physical uplink control channel resource is used for repetition of transmissions; and means for transmitting the hybrid automatic repeat request acknowledgment, using the determined physical uplink control channel resource for repetition.

Example 44. An apparatus includes means for transmitting a message with a physical downlink shared channel; and means for receiving a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

Example 45. A non-transitory program storage device readable by a machine, tangibly embodying a program of instructions executable with the machine for performing operations, the operations comprising: receiving a message with a physical downlink shared channel; determining a physical uplink control channel resource used for transmission of a hybrid automatic repeat request acknowledgement, based on the message received with the physical downlink shared channel; wherein the physical uplink control channel resource is used for repetition of transmissions; and transmitting the hybrid automatic repeat request acknowledgment, using the determined physical uplink control channel resource for repetition.

Example 46. A non-transitory program storage device readable by a machine, tangibly embodying a program of instructions executable with the machine for performing operations, the operations comprising: transmitting a message with a physical downlink shared channel; and receiving a hybrid automatic repeat request acknowledgment with a physical uplink control channel resource, the hybrid automatic repeat request acknowledgement received based on the message transmitted with the physical downlink shared channel; wherein the physical uplink control channel resource is used for repetition of transmissions; wherein the hybrid automatic repeat request acknowledgement is received with the physical uplink control channel resource for repetition without having transmitted a dedicated physical uplink control channel configuration.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, or number):
4G fourth generation
5G fifth generation
5GC 5G core network
ACK acknowledgement
AMF access and mobility management function
ASIC application-specific integrated circuit
BWP bandwidth part
CD compact/computer disc
Config configuration
CPU central processing unit
CRC cyclic redundancy check
CS cyclic shift
CU central unit or centralized unit
DCI downlink control information
DL or dl downlink
DMRS demodulation reference symbol
DSP digital signal processor
DVD digital versatile disc
EDGE enhanced data rates for GSM evolution
eNB evolved Node B (e.g., an LTE base station)
EN-DC E-UTRAN new radio-dual connectivity en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FPGA field-programmable gate array
FR frequency range
G GERAN
GERAN GSM EDGE radio access network
GSM global system for mobile communications
gNB base station for 5G/NR, i.e., a node providing NR user plane and control plane protocol terminations towards the UE, and connected via the NG interface to the 5GC
HARQ hybrid automatic repeat request
IAB integrated access and backhaul
ID identifier
I/F interface
I/O input/output
LEO low earth orbit
LMF location management function
LOS line of sight
LSB least significant bit
LTE long term evolution (4G)
MAC medium access control
MCS modulation and coding scheme
MME mobility management entity
MRO mobility robustness optimization
MSB most significant bit
MSG3 or Msg3 third message in a random access response procedure
MSG4 or Msg4 fourth message in a random access response procedure
MSGB message b in a random access response procedure
NCE network control element
ng or NG new generation
ng-eNB new generation eNB
NG-RAN new generation radio access network
NR new radio (5G)
NTN non-terrestrial network
N/W network
PBCH physical broadcast channel
PDA personal digital assistant
PDCP packet data convergence protocol
PDSCH physical downlink shared channel
PHY physical layer
PRB physical resource block
PRI resource offset indicator, or value of a bit indicator
PUCCH physical uplink control channel
PUSCH physical uplink shared channel
RACH random access channel
RAM random access memory
RAN radio access network
RAN1 radio layer 1
RAN4 radio layer 4
RAR random access response
RB or rb resource block
Rel-release
RLC radio link control
RNTI radio network temporary identifier
ROM read-only memory
RP RAN meeting
r_pucch or r_{PUCCH} PUCCH resource index
RRC radio resource control (protocol)
RU radio unit
Rx receiver or reception
SA system aspects
SGW serving gateway
SIB system information block
SMF session management function
SON self-organizing/optimizing network
SS synchronization signal
ssb synchronization signal block
TC temporary cell
tdd or TDD time division duplex
TRP transmission reception point
TS technical specification
Tx transmitter or transmission
UAV unmanned aerial vehicle
UE user equipment (e.g., a wireless, typically mobile device)
UL uplink
UPF user plane function
USB universal serial bus
WI work item
WID work item description
X2 network interface between RAN nodes and between RAN and the core network
Xn network interface between NG-RAN nodes

1. An apparatus comprising:
at least one processor; and
at least one memory storing instructions that, when executed by the at least one processor, cause the apparatus at least to:
receive a message with a physical downlink shared channel;
determine a physical uplink control channel resource used for transmission of a hybrid automatic repeat request acknowledgement, based on the message received with the physical downlink shared channel;
wherein the physical uplink control channel resource is used for repetition of transmissions; and
transmit the hybrid automatic repeat request acknowledgment, using the determined physical uplink control channel resource for repetition.

2. The apparatus of claim 1, wherein the apparatus is further caused to:
determine the physical uplink control channel resource for repetition without having received a dedicated physical uplink control channel configuration.

3. The apparatus of claim 1, wherein the physical uplink control channel resource is fixed for physical uplink control channel repeated transmissions.

4. The apparatus of claim 3, wherein the apparatus is caused to:
receive downlink control information comprising the physical uplink control channel resource.

5. The apparatus of claim 3, wherein the apparatus is caused to:
determine a physical resource block offset hopping pattern for a repetition of the physical uplink control channel repeated transmissions; and
apply the physical resource block offset hopping pattern for the repetition.

6. The apparatus of claim 3, wherein the apparatus is caused to:
determine a physical resource block offset hopping pattern for a repetition of the physical uplink control channel repeated transmissions; and
apply the physical resource block offset hopping pattern for the repetition;
wherein the physical resource block hopping pattern is predefined or provided within a configuration of common physical uplink control channel resources.

7-8. (canceled)

9. The apparatus of claim 1, wherein the physical uplink control channel resource is changed for a respective physical uplink control channel repeated transmission of a plurality of physical uplink control channel repeated transmissions.

10. The apparatus of claim 9, wherein the apparatus is caused to:
determine the physical uplink control channel resource for a repetition of the physical uplink control channel repeated transmissions, based on a resource offset indicator in downlink control information.

11. The apparatus of claim 9, wherein the apparatus is caused to:
determine a hopping pattern for the physical uplink control channel resource; and
determine the physical uplink control channel resource for a repeated transmission based on the hopping pattern.

12-14. (canceled)

15. The apparatus of claim 9, wherein the apparatus is caused to:
determine a physical resource block offset hopping pattern for a repetition of the physical uplink control channel repeated transmissions; and
apply the physical resource block offset hopping pattern for the repetition.

16. The apparatus of claim 9, wherein the apparatus is caused to:
determine a symbols offset for indexes associated with the physical uplink control channel resource without using a whole slot.

17. The apparatus of claim 1, wherein the apparatus is caused to:
receive downlink control information, the downlink control information configured to trigger transmission of the hybrid automatic repeat request acknowledgement;
wherein the downlink control information indicates a starting symbol; and
transmit a repeated transmission with the physical uplink control channel resource repeatedly within a slot, based on the starting symbol.

18. The apparatus of claim 17, wherein:
the downlink control information indicates the starting symbol explicitly; or
the downlink control information indicates the starting symbol implicitly based on whether a message for a physical uplink shared channel is transmitted repeatedly.

19. The apparatus of claim 17, wherein the starting symbol is 0 or 2.

20. The apparatus of claim 17, wherein the apparatus is caused to:
receive a row index with the downlink control information; and
determine a number of physical uplink control channel repeated transmissions at least partially based on the row index.

21. An apparatus comprising:
at least one processor; and
at least one memory storing instructions that, when executed by the at least one processor, cause the apparatus at least to:
transmit a message with a physical downlink shared channel; and
receive a hybrid automatic repeat request acknowledgment with a physical uplink control channel resource, the hybrid automatic repeat request acknowledgement received based on the message transmitted with the physical downlink shared channel;
wherein the physical uplink control channel resource is used for repetition of transmissions;
wherein the hybrid automatic repeat request acknowledgement is received with the physical uplink control channel resource for repetition without having transmitted a dedicated physical uplink control channel configuration.

22. The apparatus of claim 21, wherein the physical uplink control channel resource is fixed for physical uplink control channel repeated transmissions.

23. The apparatus of claim 22, wherein the apparatus is caused to:
transmit downlink control information comprising the physical uplink control channel resource.

24-28. (canceled)

29. The apparatus of claim 21, wherein the physical uplink control channel resource is changed for a respective physical uplink control channel repeated transmission of a plurality of physical uplink control channel repeated transmissions.

30. The apparatus of claim 29, wherein the apparatus is caused to:
transmit downlink control information comprising a resource offset indicator;
receive a repetition of the physical uplink control channel repeated transmissions with the physical uplink control channel resource, based on the resource offset indicator in the downlink control information.

31-46. (canceled)
